(19) United States
(12) Patent Application Publication
(10) Pub. No.: US 2024/0404509 A1
(43) Pub. Date: Dec. 5, 2024

(54) Method and Device for Zero-Shot Speech Generation with Prosody Control and Random Speaker Generation

(71) Applicant: 42dot Inc, Seoul (KR)

(72) Inventors: Hongsun Yang, Seoul (KR); Yooncheol Ju, Seoul (KR); Jihwan Park, Seoul (KR); Hyungyong Kim, Seoul (KR); Shukjae Choi, Seoul (KR)

(21) Appl. No.: 18/678,560

(22) Filed: May 30, 2024

Related U.S. Application Data
(60) Provisional application No. 63/504,872, filed on May 30, 2023.

(51) Int. Cl. G10L 13/10; G10L 13/047; G10L 17/02; G10L 25/18

(52) U.S. Cl. CPC G10L 13/10; G10L 13/047; G10L 17/02; G10L 25/18

(57) ABSTRACT

Disclosed are a speech generation method and device for performing zero-shot speech generation by using prosody control and random speaker generation. The speech generation method may include: receiving paired text and speaker audio for an i^{th} speaker and an j^{th} utterance from a training set; inputting the speaker audio to a speaker encoder to perform extraction of a speaker identity, and obtaining first embedding representing a representation of the speaker identity; inputting the first embedding to a speaker quantizer and obtaining quantized second embedding; inputting the text and the first embedding to a text prior encoder and obtaining a first intermediate representation; inputting the first intermediate representation and the first embedding to a prosody predictor, adding a prosodic hidden representation to the first intermediate representation, and obtaining a second intermediate representation; inputting the second intermediate representation and the first embedding to an intermediate decoder, and obtaining a final representation; and converting the final representation to a waveform by using the decoder to generate speech.

### CROSS-REFERENCE TO RELATED APPLICATION

This application claims priority to and the benefit of Korean Patent Application No. 10-2024-0070691 filed in the Korean Intellectual Property Office on May 30, 2024, the entire contents of which are incorporated herein by reference.

### BACKGROUND

### (a) Field

The present disclosure relates to a speech generation method and device for performing zero-shot speech generation by using prosody control and random speaker generation.

### (b) Description of the Related Art

Recently, speech synthesis technology using neural network models has been gaining attraction. In particular, the emergence of text-to-speech (TTS) models based on deep learning has greatly improved the naturalness and fluency of synthesized speech. AI-based speech synthesis is being utilized in various fields, such as virtual assistants and voice guidance systems, and as the quality of speech synthesis improves, user experience, real-time responsiveness, and precision are improving.

Zero-shot speech generation is a technique for synthesizing speech by using speaker identities that are extracted from a given piece of audio. It is important to note that the deep neural network models that perform zero-shot speech generation may synthesize the voice and pronunciation of a new speaker without training, even if the deep neural network models have not encountered the speaker before. In other words, in the zero-shot speech generation, the voice characteristics of a new speaker may be recognized by using pre-trained models and natural speech based on the recognized voice characteristics may be generated, and research is ongoing to improve the practicality of the technology.

### SUMMARY

The present disclosure attempts to provide a speech generation method and device capable of controlling prosody elements of generated speech, such as pitch, in zero-shot speech generation.

The present disclosure also attempts to provide a speech generation method and device capable of providing random generation of a speaker identity in zero-shot speech generation.

An exemplary embodiment of the present disclosure provides a speech generation method of performing zero-shot speech generation by using prosody control and random speaker generation, the speech generation method including: receiving paired text and speaker audio for an i^{th} speaker and an j^{th} utterance from a training set; inputting the speaker audio to a speaker encoder to perform extraction of a speaker identity, and obtaining first embedding representing a representation of the speaker identity; inputting the first embedding to a speaker quantizer and obtaining quantized second embedding; inputting the text and the first embedding to a text prior encoder and obtaining a first intermediate representation; inputting the first intermediate representation and the first embedding to a prosody predictor, adding a prosodic hidden representation to the first intermediate representation, and obtaining a second intermediate representation; inputting the second intermediate representation and the first embedding to an intermediate decoder, and obtaining a final representation; and converting the final representation to a waveform by using the decoder to generate speech.

In some exemplary embodiments, the speech generation method may further include: inputting a linear spectrogram and the first embedding to a speech post encoder and obtaining a third intermediate representation; and aligning the third intermediate representation to the first intermediate representation.

In some exemplary embodiments, the obtaining of the first embedding may further include introducing a first loss according to Equation 1 below.

$${ℒ}_{spk \_ classification} = {𝔼}_{{g}_{c o n t i n u o u s , i , j} - S} \{ - {\sum }_{i = 1}^{C} {l}_{i} log ( {f}_{spk} ( {g}_{c o n tinuous , i , j} ; {W}_{spk} ) ) \} \qquad ( Equation 1 )$$

Herein, [symbol] _{g}_{_{continuous,i,j}}_{˜S} is a notation for an expected value given the training set and the first embedding as input, C is the number of speakers in the training set, lᵢ is a one-hot vector of the i^{th} speaker, fₛₚₖ is the speaker encoder, g_{continuous,i,j} is the first embedding, and Wₛₚₖ is a parameter of the speaker encoder.

In some exemplary embodiments, the obtaining of the second embedding may include: obtaining a second embedding according to Equation 2 below, based on an optimal weight for a basis vector found by a self-attention module of the speaker quantizer.

$${g}_{discrete , i , j} = {f}_{quantize} ( {g}_{c o n t i n u o u s , i , j} ; {W}_{quantize} , B ) = {\sum }_{i = 1}^{n} {w}_{i} {b}_{i} , \\ {w}_{i} - {W}_{q u a n t ize} , {b}_{i} - B , {\sum }_{i = 1}^{n} {w}_{i} = 1 \qquad ( Equation 2 )$$

Herein, f_{quantize} is the speaker quantizer, g_{continuous,i,j} is the first embedding, W_{quantize} is parameter of the speaker quantizer, and B is a codebook including n learnable vectors.

In some exemplary embodiments, the obtaining of the second embedding may include introducing a second loss according to Equation 3 below.

$${ℒ}_{quantize} = {𝔼}_{{g}_{c o n t i n u o u s , i , j} - S , {y}_{i , j} - X} \{ L ( {g}_{discrete , i , j} , {g}_{continuous , i , j} ) \} \qquad ( Equation 3 )$$

Herein, [symbol] _{g}_{_{continuous,i,j}}_{-S,y}_{_{i,j}}_{-X} is a notation for an expected value given the training set and the first embedding as input, L is a mean squared error, g_{discrete,i,j} is the second embedding, and g_{continuous,i,j} is the first embedding.

In some exemplary embodiments, the obtaining of the second intermediate representation may include generating predicted prosody values according to Equation 4 and Equation 5 below, and introducing a third loss.

$${\hat{x}}_{p r osody} = f ( {z}_{p r ior} , {g}_{c o n t i n u o u s , i , j} ; W ) \qquad ( Equation 4 )$$

$${ℒ}_{frame \_ prosody} = {𝔼}_{{g}_{c o n t i n u o u s , i , j} - S , ( {x}_{i , j} , {y}_{i , j} ) - X} \{ {\sum }_{i = 1}^{m} L ( {\hat{x}}_{p r osody , m} , {x}_{p r osody , m} ) \} \qquad ( equation 5 )$$

Herein, f is the prosody predictor, zₚᵣᵢₒᵣ is the first intermediate representation, g_{continuous,i,j} is the first embedding, W is a parameter of the prosody predictor, [symbol] _{g}_{_{continuous,i,j}}_{-S,(x}_{_{i,j}}_{,y}_{_{i,j}}_{)-X} is a notation representing the expected value given the training set and the first embedding as input, L is a mean square error, and x_{prosody} is an actual prosody value.

In some exemplary embodiments, the obtaining of the second intermediate representation may include introducing a fourth loss according to Equation 6 below.

$${ℒ}_{token \_ prosody} = {𝔼}_{{g}_{c o n t i n u o u s , i , j} - S , ( {x}_{i , j} , {y}_{i , j} ) - X} \{ {\sum }_{k = 1}^{n} L ( \frac{{\sum }_{l ∈ {a}_{k}}^{m} {\hat{x}}_{prosody , l}}{\vert {a}_{k} \vert} , \frac{{\sum }_{l ∈ {a}_{k}}^{m} {x}_{prosody , l}}{\vert {a}_{k} \vert} ) \} \qquad ( Equation 6 )$$

Herein, [symbol] _{g}_{_{continuous,i,j}}_{-S,(x}_{_{i,j}}_{y}_{_{i,j}}_{)-X} is a notation for an expected value given the training set and the first embedding as input, L is a mean squared error, aₖ is a frame sequence corresponding to the k^{th} token of a sentence in a duration alignment between a token of the text and a mel-frame of the speaker audio, \hat{x}_{prosody} is a predicted prosody value, and x_{prosody} is an actual prosody value.

In some exemplary embodiments, the obtaining of the final representation may include introducing a fifth loss according to Equation 7 below.

$${ℒ}_{intermediate} = {𝔼}_{{g}_{continuous , i , j} - S , ( {x}_{i , j} , {y}_{i , j} ) - X} \{ L ( f ( {z}_{prosody} , {g}_{continuous , i , j} ; W ) , {x}_{Mel} ) \} \qquad ( Equation 7 )$$

Herein, [symbol] _{g}_{_{continuous,i,j}}_{-S,(x}_{_{i,j}}_{y}_{_{i,j}}_{)-X} is a notation for an expected value given the training set and the first embedding as input, L is a mean squared error, f is the intermediate decoder, z_{prosody} is the second intermediate representation, g_{continuous,i,j} IS the first embedding, W is a parameter of the intermediate decoder, and x_{Mel} is a Mel spectrogram of an actual speaker audio.

In some exemplary embodiments, the speech post encoder may include a context organizer for removing speaker information from the linear spectrogram while preserving context information; and a speaker organizer for implanting the speaker information into an output of the context organizer, and the obtaining of the third intermediate representation may include introducing a sixth loss according to Equation 8 below.

$${ℒ}_{adv \_ spk} = {max}_{{W}_{post}} {𝔼}_{{g}_{continuous , i , j} - S , {y}_{i , j} - X} \{ - {\sum }_{i = 1}^{C} {l}_{i} log ( {f}_{c o n t e x t} ( {y}_{i , j} ; {W}_{post \_ context} ) ) \} \qquad ( Equation 8 )$$

Herein, Wₚₒₛₜ is a parameter of the speech post encoder, [symbol] _{g}_{_{continuous,i,j}}_{-S,y}_{_{i,j}}_{-X} is a notation for an expected value given the training set and the first embedding as input, C is the number of speakers in the training set, lᵢ is a one-hot vector of the i^{th} speaker, f_{context} is the context organizer, y_{i,j} is the speaker audio, and W_{post_context} is a parameter of the context organizer.

In some exemplary embodiments, the obtaining of the third intermediate representation may include introducing a seventh loss according to Equation 9 below,

$${ℒ}_{s p k} = {max}_{{W}_{post}} {𝔼}_{{g}_{continuous , i , j} - S , {y}_{i , j} - X} \{ - {\sum }_{i = 1}^{C} {l}_{i} log ( {f}_{spk} ( {f}_{c o n t e x t} ( {y}_{i , j} ; {W}_{post \_ context} ) ; {W}_{post \_ spk} ) ) \} \qquad ( Equation 9 )$$

Herein, Wₚₒₛₜ is a parameter of the post-speech encoder, [symbol] _{g}_{_{continuous,i,j}}_{-S,y}_{_{i,j}}_{-X} is a notation for an expected value given the training set and the first embedding as input, C is the number of speakers in the training set, lᵢ is a one-hot vector of the i^{th} speaker, fₛₚₖ is the speaker organizer, f_{context} is the context organizer, and y_{i,j} is the speaker audio, W_{post_context} is a parameter of the context organizer, and W_{post_spk} us a parameter of the speaker organizer.

In some exemplary embodiments, the aligning of the third intermediate representation to the first intermediate representation may include introducing an eighth loss according to Equation 10 below,

$${ℒ}_{bridge} = {𝔼}_{{g}_{c o n t i n u o u s , i , j - S , ( {x}_{i , j} , {y}_{i , j} ) - X}} \{ L ( {z}_{post} , {z}_{p r i o r} ) \} \qquad ( Equation 10 )$$

Herein, [symbol] _{g}_{_{continuous,i,j}}_{-S,(x}_{_{i,j}}_{,y}_{_{i,j}}_{)-X} is a notation for an expected value given the training set and the first embedding as input, L is a mean squared error, zₚₒₛₜ is the third intermediate representation, and zₚᵣᵢₒᵣ is the first intermediate representation.

In some exemplary embodiments, the first intermediate representation may be computed according to Equation 11 below,

$${z}_{p r i o r} = {f}_{p r i o r} ( {X}_{i , j} , {g}_{c o n t i n u o u s , i , j} ; {W}_{spk} , {W}_{p r i o r} ) \qquad ( Equation 11 )$$

Herein, fₚᵣᵢₒᵣ is the text prior encoder, x_{i,j} is the text, g_{continuous,i,j} is the first embedding, Wₛₚₖ is a parameter of the speaker encoder, and Wₚᵣᵢₒᵣ may be a parameter of the text prior encoder.

In some exemplary embodiments, the third intermediate representation may be computed according to Equation 12 below.

$${z}_{p o s t} = {f}_{p o s t} ( {y}_{i , j} , {g}_{c o n t i n u o u s , i , j} ; {W}_{spk} , {W}_{p o s t} ) \qquad ( Equation 12 )$$

Herein, fₚₒₛₜ is the speech post encoder, y_{i,j} is the speaker audio, g_{continuous,i,j} is the first embedding, Wₛₚₖ is a parameter of the speaker encoder, and Wₚₒₛₜ is a parameter of the speech post encoder.

In some exemplary embodiments, the speech generation method may further include implementing zero-shot text-to-speech (TTS) based on the first embedding and the first intermediate representation, or implementing zero-shot voice conversion (VC) based on the first embedding, the first intermediate representation, and the third intermediate representation.

In some exemplary embodiments, the speech generation method may further include implementing random speaker text-to-speech (TTS) based on the second embedding and the first intermediate representation, or implementing random speaker voice conversion (VC) based on the second embedding, the first intermediate representation, and the third intermediate representation.

In some exemplary embodiments, the speech generation method may further include inputting a random seed into the speaker quantizer.

Another exemplary embodiment of the present disclosure provides a speech generation device that executes a program code loaded into one or more memory devices via one or more processors and performs zero-shot speech generation by using prosody control and random speaker generation, in which the program code is executed to: receive paired text and speaker audio for an i^{th} speaker and a j^{th} utterance from a training set; input the speaker audio to a speaker encoder to perform extraction of a speaker identity, and obtain first embedding representing a representation of the speaker identity; input the first embedding to a speaker quantizer and obtain quantized second embedding; input the text and the first embedding to a text prior encoder and obtain a first intermediate representation; input the first intermediate representation and the first embedding to a prosody predictor, and add a prosodic hidden representation to the first intermediate representation, and obtain a second intermediate representation; input the second intermediate representation and the first embedding to an intermediate decoder and obtain a final representation; and convert the final representation to a waveform by using the decoder to generate speech.

In some exemplary embodiments, the program code may be executed to further input a linear spectrogram and the first embedding to a speech post encoder and obtain a third intermediate representation, and align the third intermediate representation to the first intermediate representation.

In some exemplary embodiments, the program code may be executed to further implement zero-shot text-to-speech (TTS) based on the first embedding and the first intermediate representation, or implement zero-shot voice conversion (VC) based on the first embedding, the first intermediate representation, and the third intermediate representation.

In some exemplary embodiments, the program code may be executed to further implement random speaker text-to-speech (TTS) based on the second embedding and the first intermediate representation, or implement random speaker voice conversion (VC) based on the second embedding, the first intermediate representation, and the third intermediate representation.

### BRIEF DESCRIPTION OF THE DRAWINGS

FIG. 1 is a block diagram illustrating a speech generation device according to an exemplary embodiment.

FIG. 2 is a diagram illustrating a training pipeline of a speech generation device according to the exemplary embodiment.

FIG. 3 is a diagram illustrating an inference pipeline of the speech generation device according to the exemplary embodiment.

FIG. 4 is a flow diagram illustrating a speech generation method according to an exemplary embodiment.

FIG. 5 is a diagram illustrating a computing device according to an exemplary embodiment.

### DETAILED DESCRIPTION

Hereinafter, the present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various constituent elements, but the constituent elements are not limited by the terms. The terms are used only to discriminate one constituent element from another constituent element.

Terms, such as “ . . . unit,” “ . . . device,”, and “module,”, as used in the specification may refer to a unit capable of performing at least one function or operation described herein, which may be implemented in hardware or circuit, software, or a combination of hardware or circuit and software. Further, at least some configurations or functions of a speech generation method and device for performing zero-shot speech generation by using prosody control and random speaker generation according to exemplary embodiments described below may be implemented as a program or software, and the program or software may be stored on a computer-readable medium.

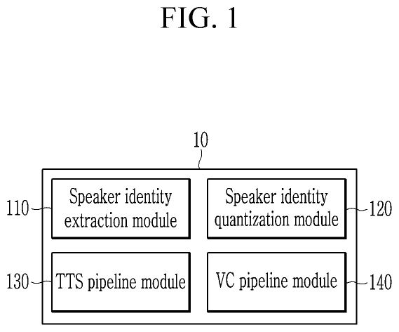

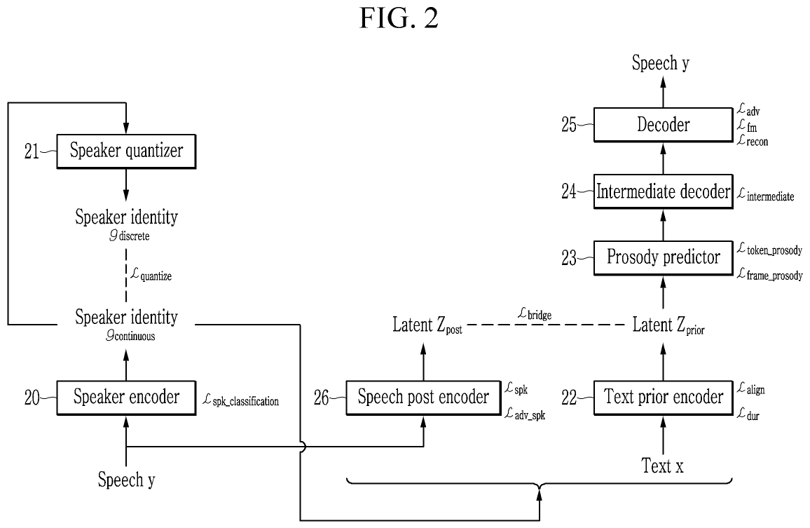

FIG. 1 is a block diagram illustrating a speech generation device according to an exemplary embodiment, and FIG. 2 is a diagram illustrating a training pipeline of a speech generation device according to the exemplary embodiment.

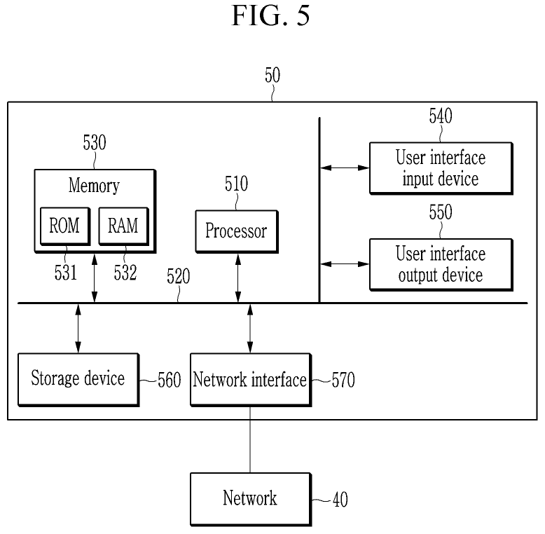

Referring to FIG. 1, a speech generation device 10 according to an exemplary embodiment may execute program codes loaded into one or more memory devices via one or more processors. For example, the speech generation device 10 may be implemented as a computing device 50, such as that described later with reference to FIG. 5. In this case, the one or more processors may correspond to the processor 510 of the computing device 50, and the one or more memory devices may correspond to the memory 520 of the computing device 50. The program code may be executed by the one or more processors to perform zero-shot speech generation by using prosodic control and random speaker generation. In the present specification, the term “module” is used to logically distinguish the functions performed by the program code from each other.

The speech generation device 10 may perform zero-shot speech generation. Zero-shot speech generation is the generation of speech by using a representation of a speaker extracted from audio of a previously unseen speaker, and a neural network model performing the zero-shot speech generation does not need to undergo any adaptation process to learn and generate speech of a new speaker. The speech generation device 10 may include a speaker identity extraction module 110, a speaker identity quantization module 120, a text-to-speech (TTS) pipeline module 130, and a voice conversion (VC) pipeline module 140 to enable control of prosody elements including pitch, and provide random generation of speaker identities in zero-shot speech generation. Hereinafter, the speaker identity extraction module 110, the speaker identity quantization module 120, the TTS pipeline module 130, and the VC pipeline module 140 will be described with reference to FIGS. 1 and 2 together.

The speech generation device 10 may be trained to generate a speech ŷ_{i,j} that is similar to ground-truth y_{i,j}, for given text x_{i,j} and speaker audio y_{i,j} as input, as follows.

$${\hat{y}}_{i , j} = f ( ( {x}_{i , j} , {y}_{i , j} ) - X ; {W}_{spk} , {W}_{t 2 s} )$$

Herein, x_{i,j} and y_{i,j} may be paired sentence and audio for the i^{th} speaker and j^{th} utterance from a specific training set X (where i, j are integers). f is a TTS pipeline, and Wₛₚₖ and Wₜ₂ₛ may be a parameter of the speaker encoder 20 and a parameter of the TTS pipeline, respectively. Herein, the TTS pipeline may include a text prior encoder 22, a prosody predictor 23, an intermediate decoder 24, and a decoder 25. Meanwhile, a speech post encoder 26 may form a VC pipeline.

For example, the output zₚₒₛₜ of the VC pipeline may be aligned with an output zₚᵣᵢₒᵣ of a frame decoder of the text prior encoder 22 of the TTS pipeline, and an output g_{discrete} of a speaker quantizer 21 may follow an output g_{continuous} of the speaker encoder 20. In this way, the speech generation device 10 may build a jointly trainable pipeline to realize applications for various applications, such as zero-shot TTS, VC, random speaker generation, and prosody control, with only a single-step training for the neural network, and to this end, the total loss Lₜₒₜₐₗ for the single-step training is introduced in the following form.

$${ℒ}_{total} = {ℒ}_{TriniTTS} + {λ}_{frame \_ prosody} {ℒ}_{frame \_ prosody} + {λ}_{adv \_ spk} {ℒ}_{adv \_ spk} + {λ}_{spk} {ℒ}_{spk} + {λ}_{q uantize} {ℒ}_{q uantize} + {λ}_{spk \_ classification} {ℒ}_{spk \_ classification}$$

Herein, [symbol] _{TriniTTS} is a loss term for the TTS on which the speech generation device 10 according to the exemplary embodiments is based, and each of [symbol] _{frame_prosody}, [symbol] _{adv_spk}, [symbol] ₛₚₖ, [symbol] _{quantize}, and [symbol] _{spk_classification} will be described later. λ_{frame_prosody}, λ_{adv_spk}, λₛₚₖ, λ_{quantize}, and λ_{spk_classification} may be hyperparameters for their respective loss terms.

The speaker identity extraction module 110 may perform speaker identity extraction by inputting speaker audio y_{i,j} to the speaker encoder 20, and obtain a first embedding g_{continuous} representing a representation of the speaker identity. The speaker encoder 20 is a pre-trained speaker recognition model, and in some exemplary embodiments, the speaker encoder 20 may be trained by using angular prototypical loss.

The speaker encoder 20 may receive speaker audio y_{i,j} as input and output a representation of the speaker identity g_{continuous}, as follows.

g_{continuous,i,j}=fₛₚₖ(g_{continuous,i,j};Wₛₚₖ)

Herein, fₛₚₖ is the speaker encoder 20, and Wₛₚₖ may be a parameter of the speaker encoder 20. Since the speaker encoder 20 aims to extract only speaker-specific information, the extracted speaker embedding g_{continuous,i,j} may be approximated to the speaker identity s; of the i^{th} speaker among all speakers in the training set S as follows: g_{continuous,i,j}≈Si where si˜S. In the speaker encoder 20, the extracted representation continuous may be introduced as a condition for the normalizing layer for the elements in the TTS pipeline and the VC pipeline. The extracted representation g_{continuous} may also be used as a target for the output g_{discrete} of the speaker quantizer 21. To make the speaker embedding (i.e., the first embedding) more discriminative, a speaker classifier may be added to the output of the speaker encoder 20, and a loss @@@ may be introduced for the speaker classifier according to Equation 1 below.

$${ℒ}_{spk \_ classification} = {𝔼}_{{g}_{cont i n u o u s , i , {j}^{- S}}} \{ - {\sum }_{i = 1}^{C} {l}_{i} log ( {f}_{s p k} ( {g}_{c o n t inuous , i , j} ; {W}_{s p k} ) ) \} \qquad ( Equation 1 )$$

Herein, [symbol] _{g}_{_{continuous,i,j}}_{˜S} may be a notation for the expected value given the training set S and the first embedding as input, C may be the number of speakers in the training set S, lᵢ may be the one-hot vector of the i^{th} speaker, fₛₚₖ may be the speaker encoder 20, g_{continuous,i,j} may be the first embedding, and Wₛₚₖ may be a parameter of the speaker encoder 20.

The speaker identity quantization module 120 may input the first embedding g_{continuous} obtained from the speaker encoder 20 to the speaker quantizer 21 and obtain a quantized second embedding g_{discrete}. The speaker quantizer 21 may aim to reconstruct the extracted g_{continuous} as a weighted sum of basis vectors bᵢ, i=1, . . . , n corresponding to a set of n learnable vectors from a codebook B. To this end, a second embedding g_{discrete} may be obtained according to Equation 2 below based on an optimal weight wᵢ for the basis vector bᵢ found by the self-attention module of the speaker quantizer 21. That is, the reconstructed second embedding g_{discrete} may be computed as the sum of the products of the basis vector bᵢ and the weight wᵢ computed from the attention layer.

$${g}_{discrete , i , j} = {f}_{quantize} ( {g}_{c o n t i n u o u s , i , j} ; {W}_{quantize} , B ) = {\sum }_{i = 1}^{n} {w}_{i} {b}_{i} , {w}_{i} - {W}_{q u a n t ize} , {b}_{i} - B , {\sum }_{i = 1}^{n} {w}_{i} = 1 \qquad ( Equation 2 )$$

Herein, f_{quantize} may be the speaker quantizer 21, g_{continuous,i,j} may be the first embedding, W_{quantize} may be the parameter of the speaker quantizer 21, and B may be a codebook including n learnable vectors. To train the speaker quantizer 21, a speaker quantization loss, that is, a loss [symbol] _{quantize}, may be introduced between g_{continuous} and g_{discrete} by using a mean square error L, according to Equation 3 below.

$${ℒ}_{quantize} = {𝔼}_{{g}_{c o n t i n u o u s , i , j} - S , {y}_{i , j} - X} \{ L ( {g}_{discrete , i , j} , {g}_{c o n t i n u o u s , i , j} ) \} \qquad ( Equation 3 )$$

Herein, [symbol] _{g}_{_{continuous,i,j}}_{-S,y}_{_{i,j}}_{-X} may be a notation for the expected value given the training set S and the first embedding as input, L may be the mean squared error, discrete,i,j may be the second embedding, and g_{continuous,i,j} may be the first embedding.

To prevent the loss from affecting the parameter Wₛₚₖ of the speaker encoder 20, g_{continuous} may be separated from the speaker quantization loss.

The TTS pipeline module 130 may input the text x_{i,j} and the first embedding g_{continuous} to the text prior encoder 22 and obtain the first intermediate representation zₚᵣᵢₒᵣ. The text prior encoder 22 may include a phoneme encoder, an alignment search module, a duration predictor, and a frame decoder. In the phoneme encoder, the alignment search module, and the duration predictor, the first embedding, that is, the speaker embedding g_{continuous}, may be given as a condition for the normalization layers assigned to the phoneme encoder, the alignment search module, and the duration predictor.

The frame decoder may receive as input an extended text hidden representation h_{text_extended}, which is extended from the number of tokens to the number of frames after iterations of the phoneme encoder's text representation in the time-wise dimension, and the first embedding g_{continuous}. In some exemplary embodiments, the architecture of the frame decoder may be the same as the phoneme encoder.

The TTS pipeline module 130 may input the first intermediate representation zₚᵣᵢₒᵣ and the first embedding g_{continuous} to the prosody predictor 23, and add the prosodic hidden representations h_{pitch} and h_{energy} to the first intermediate representation zₚᵣᵢₒᵣ to obtain a second intermediate representation z_{prosody}. The prosody predictor 23 may receive as input the output zₚᵣᵢₒᵣ of the frame decoder and the speaker embedding g_{continuous}. The main function of the prosody predictor 23 is to generate a predicted pitch value \hat{x}_{pitch} and an energy value \hat{x}_{energy}. The normalized pitch and energy values extracted from the ground truth audio x_{pitch} and x_{energy} may be used as targets during training. When it is assumed that n is the length of the text token x_{i,j} and m is the length of the mel frame of the audio y_{i,j}, the loss term may be computed based on the length of the mel frame of y_{i,j} rather than the length of x_{i,j}. In some exemplary embodiments, the prosody prediction loss may be computed at the token level or at the frame level.

Specifically, a predicted prosody value \hat{x}_{prosody} may be generated and a loss [symbol] _{frame_prosody} may be introduced according to Equation 4 and Equation 5 below.

$${\hat{x}}_{p rosody} = f ( {z}_{prior} , {g}_{c o n t i n u o u s , i , j} ; W ) \qquad ( Equation 4 )$$

$${ℒ}_{frame \_ prosody} = {𝔼}_{{g}_{c o n t i n u o u s , i , j} - S , ( {x}_{i , j} , {y}_{i , j} ) - X} \{ {\sum }_{i = 1}^{m} L ( {\hat{x}}_{p rosody , m} , {x}_{p rosody , m} ) \} \qquad ( Equation 5 )$$

Herein, f is the prosody predictor 23, zₚᵣᵢₒᵣ is the first intermediate representation, continuous,i,j may be the first embedding, W may be the parameter of the prosody predictor 23, [symbol] _{g}_{_{continuous,i,j}}_{-S,(x}_{_{i,j}}_{,y}_{_{i,j}}_{)-X} may be a notation representing the expected value given the training set S and the first embedding as input, L may be the mean square error, and x_{prosody} may be the actual prosody value.

In addition, a loss [symbol] _{token_prosody} may be introduced according to Equation 6 below.

$${ℒ}_{token \_ prosody} = {𝔼}_{{g}_{c o n t i n u o u s , i , j} - S , ( {x}_{i , j} , {y}_{i , j} ) - X} \{ {\sum }_{k = 1}^{n} L ( \frac{{\sum }_{l ∈ {a}_{k}}^{m} {\hat{x}}_{p rosody} , l}{\vert {a}_{k} \vert} , \frac{{\sum }_{l ∈ {a}_{k}}^{m} {x}_{p rosody} , l}{\vert {a}_{k} \vert} ) \} \qquad ( Equation 6 )$$

Herein, [symbol] _{g}_{_{continuous,i,j}}_{-S,(x}_{_{i,j}}_{,y}_{_{i,j}}_{)-X} may be the notation for the expected value given the training set S and the first embedding as input, L may be the mean squared error, aₖ may be the frame sequence corresponding to the k^{th} token of the sentence in the duration alignment between the token of the text x_{i,j} and the mel-frame of the speaker audio y_{i,j}, \hat{x}_{prosody} may be the predicted prosody value, and x_{prosody} may be the actual prosody value.

In the training stage, the ground truth audio x_{pitch} and x_{energy} may be delivered to the prosody encoder to generate prosodic hidden representations h_{pitch} and h_{energy}. These hidden representations may then be added to the output zₚᵣᵢₒᵣ of the frame decoder. However, in the inference stage, the predicted prosody values \hat{x}_{pitch} and \hat{x}_{energy} are delivered to the encoder, and the prosody may be controlled by adjusting the values using parameters.

The TTS pipeline module 130 may input the second intermediate representation z_{prosody} and the first embedding g_{continuous} to the intermediate decoder 24 to obtain a final representation z_{final}. The intermediate decoder 24 may receive the output z_{prosody} of the prosody predictor 23 along with the speaker embedding g_{continuous} as input. In some exemplary embodiments, the intermediate decoder 24 may include a fully convolutional neural network with residual connection to capture local information. The intermediate decoder 24 may be the final stage of the intermediate representation before up-sampling is performed on the waveform. To align the output z_{final} of the intermediate decoder 24 with the Mel-spectrogram of the ground truth audio xₘₑₗ with the mean square error L, a loss [symbol] _{intermediate} may be introduced according to Equation 7 below.

$${ℒ}_{intermediate} = {𝔼}_{{g}_{continuous , i , j} - S , ( {x}_{i , j} , {y}_{i , j} ) - X} \{ L ( f ( {z}_{prosody} , {g}_{c o n t i n u o u s , i , j} ; W ) , {x}_{Mel} ) \} \qquad ( Equation 7 )$$

Herein, [symbol] _{g}_{_{continuous,i,j}}_{-S,(x}_{_{i,j}}_{,y}_{_{i,j}}_{)-X} is the notation for the expected value given the training set S and the first embedding as input, L may be the mean squared error, f may be the intermediate decoder 24, z_{prosody} may be the second intermediate representation, g_{continuous,i,j} may be the first embedding, W may be the parameter of the intermediate decoder 24, and x_{Mel} may be the Mel spectrogram of the actual speaker audio.

The TTS pipeline module 130 may convert the final representation z_{final} to a waveform to generate the speech ŷ_{i,j} by using the decoder 25. In some exemplary embodiments, the decoder 25 may be implemented as a generative adversarial network (GAN)-based decoder.

The VC pipeline module 140 may input a linear spectrogram x_{spec} and the first embedding g_{continuous} to the speech post encoder 26, obtain the third intermediate representation zₚₒₛₜ, and align the third intermediate representation zₚₒₛₜ to the first intermediate representation zₚᵣᵢₒᵣ. The speech post encoder 26 may learn the intermediate representations of the TTS pipeline on-the-fly during training. The speech post encoder 26 may receive as input the linear spectrogram x_{spec} and the speaker embedding g_{continuous}, and output a latent variable zₚₒₛₜ that best represents the context and speaker information. The speech post encoder 26 may include a context organizer and a speaker organizer.

A context organizer may remove speaker information from the linear spectrogram x_{spec} while preserving contextual information. On the other hand, the speaker organizer may implant speaker information into the output of the context organizer. To ensure that the speaker information is removed after the context organizer, an adversarial speaker classifier may be added to the output of the context organizer. In this regard, a loss [symbol] _{adv_spk} may be introduced according to Equation 8 below.

$${ℒ}_{adv \_ spk} = {max}_{{W}_{post}} {𝔼}_{{g}_{continuous , i , j} - S , {y}_{i , j} - X} \{ - {\sum }_{i = 1}^{C} {l}_{i} log ( {f}_{c o n t e x t} ( {y}_{i , j} ; {W}_{p o s {t}_{-} c o n t e x t} ) ) \} \qquad ( Equation 8 )$$

Herein, Wₚₒₛₜ is the parameter of the speech post encoder 26, [symbol] _{g}_{_{continuous,i,j}}_{-S,y}_{_{i,j}}_{-X} may be a notation for the expected value given the training set S and the first embedding as input, C may be the number of speakers in the training set S, lᵢ may be the one-hot vector of the i^{th} speaker, f_{context} may be the context organizer, y_{i,j} may be the speaker audio, and W_{post_context} may be the parameter of the context organizer.

Further, a speaker classifier may be added to the output of the speaker organizer to implant speaker information from a target speaker reference. In this regard, a loss [symbol] ₛₚₖ may be introduced according to Equation 9 below.

$${ℒ}_{spk} = {max}_{{W}_{p o s t}} {𝔼}_{{g}_{c o n t i n u o u s , i , j} - S , {y}_{i , j} - X} \{ - {\sum }_{i = 1}^{C} {l}_{i} log ( {f}_{spk} ( {f}_{c o n t e x t} ( {y}_{i , j} ; {W}_{post \_ context} ) ; {W}_{post \_ spk} ) ) \} \qquad ( Equation 9 )$$

Herein, Wₚₒₛₜ is the parameter of the speech post encoder 26, [symbol] _{g}_{_{continuous,i,j}}_{-S,y}_{_{i,j}}_{-X} may be the notation for the expected value given the training set S and the first embedding as input, C may be the number of speakers in the training set S, lᵢ may be the one-hot vector of the i^{th} speaker, fₛₚₖ may be the speaker organizer, f_{context} may be the context organizer, and y_{i,j} may be the speaker audio, Wₚₒₛₜ context may be the parameter of the context organizer, and W_{post_spk} may be the parameter of the speaker organizer.

To ensure that the output zₚₒₛₜ of the speaker organizer after the context organizer is aligned with the output zₚᵣᵢₒᵣ of the frame decoder, a loss [symbol] _{bridge} may be introduced according to Equation 10 below.

$${ℒ}_{bridge} = {𝔼}_{{g}_{cont i n u o u s , i , j - S , ( {x}_{i , j} , {y}_{i , j} ) - X}} \{ L ( {z}_{p ost} , {z}_{p r i o r} ) \} \qquad ( Equation 10 )$$

Herein, [symbol] _{g}_{_{continuous,i,j}}_{-S,(x}_{_{i,j}}_{,y}_{_{i,j}}_{)-X} is a notation for the expected value given the training set S and the first embedding as input, L may be the mean squared error, zₚₒₛₜ may be the third intermediate representation, and zₚᵣᵢₒᵣ may be the first intermediate representation.

In some exemplary embodiments, the first intermediate representation zₚᵣᵢₒᵣ may be computed according to Equation 11 below.

$${z}_{p r i o r} = {f}_{p r i o r} ( {x}_{i , j} , {g}_{c o n t i n u o u s , i , {j}^{;}} {W}_{spk} , {W}_{prior} ) \qquad ( Equation 11 )$$

Herein, fₚᵣᵢₒᵣ is the text prior encoder 22, x_{i,j} is the text, g_{continuous,i,j} is the first embedding, Wₛₚₖ is a parameter of the speaker encoder 20, and Wₚᵣᵢₒᵣ may be a parameter of the text prior encoder 22.

In some exemplary embodiments, the third intermediate representation zₚₒₛₜ may be computed according to Equation 12 below.

$${z}_{p o s t} = {f}_{p o s t} ( {y}_{i , j} , {g}_{c o n t i n u o u s , i , j} ; {W}_{spk} , {W}_{p o s t} ) \qquad ( Equation 12 )$$

Herein, fₚₒₛₜ may be the speech post encoder 26, y_{i,j} may be the speaker audio, g_{continuous,i,j} may be the first embedding, Wₛₚₖ may be a parameter of the speaker encoder 20, and Wₚₒₛₜ may be a parameter of the speech post encoder 26.

According to the present exemplary embodiment, pitch control may be implemented in zero-shot speech generation by integrating the TTS pipeline, the VC pipeline, and the prosody predictor, while new speaker identities may be introduced in speech generation according to the use of the codebook of the speaker quantizer. Furthermore, by building a jointly trainable pipeline, the application to various applications, including zero-shot TTS, VC, random speaker generation, and prosody control, may be implemented only with a single step training of the neural network. Furthermore, by sharing the prosody predictor and the decoder, computational costs may be reduced and efficiency increased.

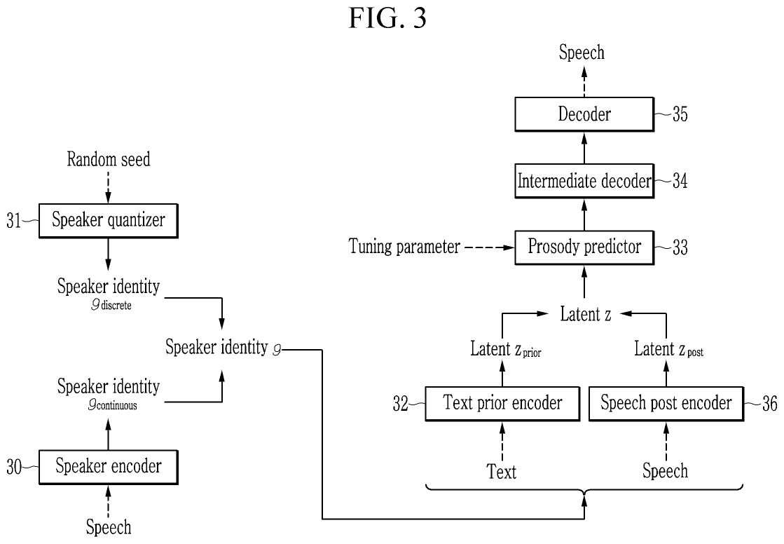

FIG. 3 is a diagram illustrating the inference pipeline of the speech generation device according to the exemplary embodiment.

Referring now to FIG. 3, the trained speech generation device 10, as described in FIG. 2, may be used to implement applications, such as zero-shot speech generation, random speaker generation, and prosody control. In FIG. 3, a speaker encoder 30, a speaker quantizer 31, a text prior encoder 32, a prosody predictor 33, an intermediate decoder 34, a decoder 35, and a speech post encoder 36 may correspond to the speaker encoder 20, the speaker quantizer 21, the text prior encoder 22, the prosody predictor 23, the intermediate decoder 24, the decoder 25, and the speech post encoder 26 of FIG. 2.

In some exemplary embodiments, a zero-shot text-to-speech (TTS) may be implemented based on the first embedding g_{continuous} and the first intermediate representation zₚᵣᵢₒᵣ. Further, a zero-shot voice conversion (VC) may be implemented based on the first embedding g_{continuous}, the first intermediate representation zₚᵣᵢₒᵣ, and the third intermediate representation zₚₒₛₜ.

In some exemplary embodiments, a random speaker text-to-speech (TTS) may be implemented based on the second embedding g_{discrete} and the first intermediate representation zₚᵣᵢₒᵣ. Further, a random speaker voice conversion (VC) may be implemented based on the second embedding g_{discrete}, the first intermediate representation zₚᵣᵢₒᵣ, and the third intermediate representation zₚₒₛₜ. In this case, a random seed may be input to the speaker quantizer 31.

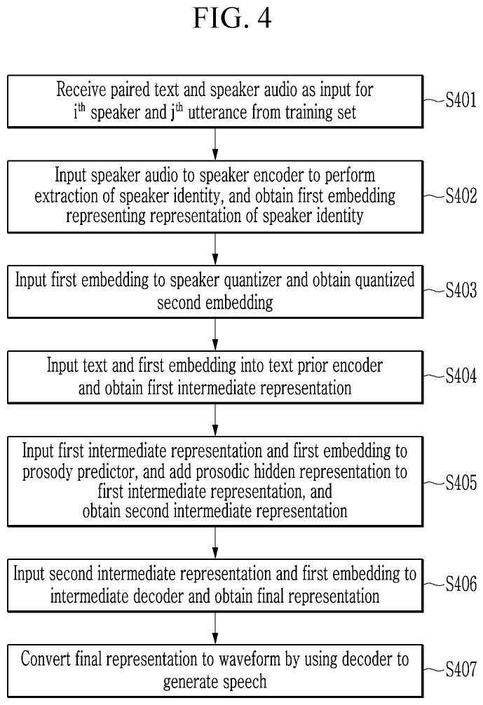

FIG. 4 is a flow diagram illustrating a speech generation method according to an exemplary embodiment.

Referring now to FIG. 4, the speech generation method according to the exemplary embodiment may include receiving paired text and speaker audio as input for the i^{th} speaker and the j^{th} utterance from a training set (S401), inputting the speaker audio to a speaker encoder to perform an extraction of a speaker identity, and obtaining a first embedding representing a representation of the speaker identity (S402), inputting the first embedding to a speaker quantizer and obtaining a quantized second embedding (S403), inputting the text and the first embedding into a text prior encoder and obtaining a first intermediate representation (S404), inputting the first intermediate representation and the first embedding to a prosody predictor, adding a prosodic hidden representation to the first intermediate representation, and obtaining a second intermediate representation (S405), inputting the second intermediate representation and the first embedding to an intermediate decoder and obtaining a final representation (S406); and converting the final representation to a waveform by using the decoder to generate speech (S407).

For a more detailed description of the above method, reference may be made to the description of the exemplary embodiments described herein, so that duplicative descriptions are omitted herein.

FIG. 5 is a diagram illustrating a computing device according to an exemplary embodiment.

Referring to FIG. 5, the speech generation method and device according to the exemplary embodiments may be implemented using a computing device 50.

The computing device 50 may include at least one of a processor 510, a memory 530, a user interface input device 540, a user interface output device 550, and a storage device 560 communicating via a bus 520. The computing device 50 may also include a network interface 570 electrically connected to the network 40. The network interface 570 may transmit or receive signals to and from other entities over the network 40.

The processor 510 may be implemented in various types, such as a microcontroller unit (MCU), application processor (AP), central processing unit (CPU), graphic processing unit (GPU), neural processing unit (NPU), and quantum processing unit (QPU), and may be any semiconductor device that executes instructions stored in the memory 530 or the storage device 560. The processor 510 may be configured to implement the functions and methods described above with respect to FIGS. 1 to 4.

The memory 530 and the storage device 560 may include various forms of volatile or non-volatile storage media. For example, the memory may include a read-only memory (ROM) 531 and a random access memory (RAM) 532. In some exemplary embodiments, the memory 530 may be located inside or outside of the processor 510, and the memory 530 may be coupled to the processor 510 through various means already known in the art.

In some exemplary embodiments, at least some configurations or functions of the speech generation method and device according to the exemplary embodiments may be implemented as programs or software executing on the computing device 50, and the programs or software may be stored on a computer-readable medium. Specifically, the computer-readable medium according to the exemplary embodiment may be a computer, including a processor 510 that executes programs or instructions stored in the memory 530 or the storage device 560, that records a program for executing steps included in implementing the speech generation method and device according to the exemplary embodiment.

In some exemplary embodiments, at least some configurations or functions of the speech generation method and device according to the exemplary embodiments may be implemented using hardware or circuit of the computing device 50, or may be implemented as separate hardware or circuit that may be electrically connected to computing device 50.

According to the exemplary embodiments, pitch control may be implemented in zero-shot speech generation by integrating the TTS pipeline, the VC pipeline, and the prosody predictor, while new speaker identities may be introduced in speech generation by using the speaker quantizer's codebook. Furthermore, by building the jointly trainable pipeline, the application to various applications, including zero-shot TTS, VC, random speaker generation, and prosody control, may be implemented only with a single step training of the neural network.

Although the above exemplary embodiments of the present invention have been described in detail, the scope of the present invention is not limited thereto, but also includes various modifications and improvements by one of ordinary skill in the art utilizing the basic concepts of the present invention as defined in the following claims.

What is claimed is:

1. A speech generation method of performing zero-shot speech generation by using prosody control and random speaker generation, the speech generation method comprising:
receiving paired text and speaker audio for an ith speaker and an jth utterance from a training set;
inputting the speaker audio to a speaker encoder to perform extraction of a speaker identity, and obtaining first embedding representing a representation of the speaker identity;
inputting the first embedding to a speaker quantizer and obtaining quantized second embedding;
inputting the text and the first embedding to a text prior encoder and obtaining a first intermediate representation;
inputting the first intermediate representation and the first embedding to a prosody predictor, adding a prosodic hidden representation to the first intermediate representation, and obtaining a second intermediate representation;
inputting the second intermediate representation and the first embedding to an intermediate decoder, and obtaining a final representation; and
converting the final representation to a waveform by using the decoder to generate speech.

2. The speech generation method of claim 1, further comprising:
inputting a linear spectrogram and the first embedding to a speech post encoder and obtaining a third intermediate representation; and
aligning the third intermediate representation to the first intermediate representation.

3. The speech generation method of claim 1, wherein:
the obtaining of the first embedding includes
introducing a first loss according to Equation 1 below,
$${ℒ}_{spk \_ classification} = {𝔼}_{{g}_{c o n t i n u o u s , i {j}^{- S}}} \{ - {\sum }_{i = 1}^{C} {l}_{i} log ( {f}_{spk} ( {g}_{c o n t i nuous , i , j} ; {W}_{spk} ) ) \} \qquad ( Equation 1 )$$
where, [symbol] _{g}_{_{continuous,i,j}}_{˜S} is a notation for an expected value given the training set and the first embedding as input, C is the number of speakers in the training set, lᵢ is a one-hot vector of the ith speaker, fₛₚₖ is the speaker encoder, g_{continuous,i,j} is the first embedding, and Wₛₚₖ is a parameter of the speaker encoder.

4. The speech generation method of claim 1, wherein:
the obtaining of the second embedding includes
obtaining a second embedding according to Equation 2 below, based on an optimal weight for a basis vector found by a self-attention module of the speaker quantizer,
$${g}_{discrete , i , j} = {f}_{quantize} ( {g}_{continuous , i , j} ; {W}_{quantize} , B ) = {\sum }_{i = 1}^{n} {w}_{i} {b}_{i} , {w}_{i} - {W}_{q u a n t ize} , {b}_{i} - B , {\sum }_{i = 1}^{n} {w}_{i} = 1 \qquad ( Equation 2 )$$
where, f_{quantize} is the speaker quantizer, g_{continuous,i,j} is the first embedding, W_{quantize} is parameter of the speaker quantizer, and B is a codebook including n learnable vectors.

5. The speech generation method of claim 4, wherein:
the obtaining of the second embedding includes
introducing a second loss according to Equation 3 below,
$${ℒ}_{quantize} = {𝔼}_{{g}_{c o n t i n u o u s , i , j} - S , {y}_{i , j} - X} \{ L ( {g}_{discrete , i , j} , {g}_{continuous , i , j} ) \} \qquad ( Equation 3 )$$
where, [symbol] _{g}_{_{continuous,i,j}}_{-S,y}_{_{i,j}}_{-X} is a notation for an expected value given the training set and the first embedding as input, L is a mean squared error, g_{discrete,i,j} is the second embedding, and g_{continuous,i,j} is the first embedding.

6. The speech generation method of claim 1, wherein:
the obtaining of the second intermediate representation includes
generating predicted prosody values according to Equation 4 and Equation 5 below, and introducing a third loss,
$${\hat{x}}_{p rosody} = f ( {z}_{p r ior} , {g}_{c o n t i n u o u s , i , j} ; W ) \qquad ( Equation 4 )$$
$${ℒ}_{frame \_ prosody} = {𝔼}_{{g}_{c o n t i n u o u s , i , j} - S , ( {x}_{i , j} , {y}_{i , j} ) - X} \{ {\sum }_{i = 1}^{m} L ( {\hat{x}}_{p rosody , m} , {x}_{p rosody , m} ) \} \qquad ( Equation 5 )$$
where, f is the prosody predictor, zₚᵣᵢₒᵣ is the first intermediate representation, g_{continuous,i,j} is the first embedding, W is a parameter of the prosody predictor, [symbol] _{g}_{_{continuous,i,j}}_{-S,(x}_{_{i,j}}_{,y}_{_{i,j}}_{)-X} is a notation representing the expected value given the training set and the first embedding as input, L is a mean square error, and x_{prosody} is an actual prosody value.

7. The speech generation method of claim 6, wherein:
the obtaining of the second intermediate representation includes
introducing a fourth loss according to Equation 6 below,
$${ℒ}_{token \_ prosody} = {𝔼}_{{g}_{c o n t i n u o u s , i , j} - S , ( {x}_{i , j} , {y}_{i , j} ) - X} \{ {\sum }_{k = 1}^{n} L ( \frac{{\sum }_{l ∈ {a}_{k}}^{m} {\hat{x}}_{prosody , l}}{\vert {a}_{k} \vert} , \frac{{\sum }_{l ∈ {a}_{k}}^{m} {x}_{prosody , l}}{\vert {a}_{k} \vert} ) \} \qquad ( Equation 6 )$$
where, [symbol] _{g}_{_{continuous,i,j}}_{-S,(x}_{_{i,j}}_{,y}_{_{i,j}}_{)-X} is a notation for an expected value given the training set and the first embedding as input, L is a mean squared error, aₖ is a frame sequence corresponding to the k^{th} token of a sentence in a duration alignment between a token of the text and a mel-frame of the speaker audio, \hat{x}_{prosody} is a predicted prosody value, and x_{prosody} is an actual prosody value.

8. The speech generation method of claim 1, wherein:
the obtaining of the final representation includes
introducing a fifth loss according to Equation 7 below,
$${ℒ}_{intermediate} = {𝔼}_{{g}_{c o n t i n u o u s , i , j} - S , ( {x}_{i , j} , {y}_{i , j} ) - X} \{ L ( f ( {z}_{prosody} , {g}_{c o n t i n u o u s , i , j} ; W ) , {x}_{Mel} ) \} \qquad ( Equation 7 )$$
where, [symbol] _{g}_{_{continuous,i,j}}_{-S,(x}_{_{i,j}}_{,y}_{_{i,j}}_{)-X} is a notation for an expected value given the training set and the first embedding as input, L is a mean squared error, f is the intermediate decoder, z_{prosody} is the second intermediate representation, g_{continuous,i,j} IS the first embedding, W is a parameter of the intermediate decoder, and x_{Mel} is a Mel spectrogram of an actual speaker audio.

9. The speech generation method of claim 2, wherein:
the speech post encoder includes a context organizer for removing speaker information from the linear spectrogram while preserving context information; and a speaker organizer for implanting the speaker information into an output of the context organizer, and
the obtaining of the third intermediate representation includes
introducing a sixth loss according to Equation 8 below,
$${ℒ}_{adv \_ spk} = {max}_{{W}_{post}} {𝔼}_{{g}_{c o n t i n u o u s , i , j} - S , {y}_{i , j} ) - X} \{ - {\sum }_{i = 1}^{C} {l}_{i} log ( {f}_{c o n t e x t} ( {y}_{i , j} ; {W}_{post \_ context} ) ) \} \qquad ( Equation 8 )$$
where, Wₚₒₛₜ is a parameter of the speech post encoder, [symbol] _{g}_{_{continuous,i,j}}_{-S,y}_{_{i,j}}_{-X} is a notation for an expected value given the training set and the first embedding as input, C is the number of speakers in the training set, lᵢ is a one-hot vector of the ith speaker, f_{context} is the context organizer, y_{i,j} is the speaker audio, and W_{post_context} is a parameter of the context organizer.

10. The speech generation method of claim 9, wherein:
the obtaining of the third intermediate representation includes
introducing a seventh loss according to Equation 9 below,
$${ℒ}_{spk} = {max}_{{W}_{post}} {𝔼}_{{g}_{c o n t i n u o u s , i , j} - S , {y}_{i , j} ) - X} \{ - {\sum }_{i = 1}^{C} {l}_{i} log ( {f}_{spk} ( {f}_{c o n t e x t} ( {y}_{i , j} ; {W}_{post \_ context} ) ; {W}_{post \_ spk} ) ) \} \qquad ( Equation 9 )$$
where, Wₚₒₛₜ is a parameter of the speech post encoder, [symbol] _{g}_{_{continuous,i,j}}_{-S,y}_{_{i,j}}_{-X} is a notation for an expected value given the training set and the first embedding as input, C is the number of speakers in the training set, lᵢ is a one-hot vector of the ith speaker, fₛₚₖ is the speaker organizer, f_{context} is the context organizer, and y_{i,j} is the speaker audio, W_{post_context} is a parameter of the context organizer, and W_{post_spk} is a parameter of the speaker organizer.

11. The speech generation method of claim 10, wherein:
the aligning of the third intermediate representation to the first intermediate representation includes
introducing an eighth loss according to Equation 10 below,
$${ℒ}_{bridge} = {𝔼}_{{g}_{c o n t i n u o u s , i , j - S , ( {x}_{i , j} , {y}_{i , j} ) - X}} \{ L ( {z}_{p ost} , {z}_{p r i o r} ) \} \qquad ( Equation 10 )$$
where, [symbol] _{g}_{_{continuous,i,j}}_{-S,(x}_{_{i,j}}_{,y}_{_{i,j}}_{)-X} is a notation for an expected value given the training set and the first embedding as input, L is a mean squared error, zₚₒₛₜ is the third intermediate representation, and zₚᵣᵢₒᵣ is the first intermediate representation.

12. The speech generation method of claim 11, wherein:
the first intermediate representation is computed according to Equation 11 below,
$${z}_{p r i o r} = {f}_{p r i o r} ( {x}_{i , j} , {g}_{c o n t i n u o u s , i , j} ; {W}_{spk} , {W}_{p r i o r} ) \qquad ( Equation 11 )$$
where, fₚᵣᵢₒᵣ is the text prior encoder, x_{i,j} is the text, g_{continuous,i,j} is the first embedding, Wₛₚₖ is a parameter of the speaker encoder, and Wₚᵣᵢₒᵣ may be a parameter of the text prior encoder.

13. The speech generation method of claim 11, wherein:
the third intermediate representation is computed according to Equation 12 below,
$${z}_{p o s t} = {f}_{p o s t} ( {y}_{i , j} , {g}_{c o n t i n u o u s , i , j} ; {W}_{spk} , {W}_{p o s t} ) \qquad ( Equation 12 )$$
where, fₚₒₛₜ is the speech post encoder, y_{i,j} is the speaker audio, g_{continuous,i,j} is the first embedding, Wₛₚₖ is a parameter of the speaker encoder, and Wₚₒₛₜ is a parameter of the speech post encoder.

14. The speech generation method of claim 2, further comprising:
implementing zero-shot text-to-speech (TTS) based on the first embedding and the first intermediate representation, or implementing zero-shot voice conversion (VC) based on the first embedding, the first intermediate representation, and the third intermediate representation.

15. The speech generation method of claim 2, further comprising:
implementing random speaker text-to-speech (TTS) based on the second embedding and the first intermediate representation, or. implementing random speaker voice conversion (VC) based on the second embedding, the first intermediate representation, and the third intermediate representation.

16. The speech generation method of claim 15, further comprising:
inputting a random seed into the speaker quantizer.

17. A speech generation device that executes a program code loaded into one or more memory devices via one or more processors and performs zero-shot speech generation by using prosody control and random speaker generation,
wherein the program code is executed to:
receive paired text and speaker audio for an ith speaker and a jth utterance from a training set;
input the speaker audio to a speaker encoder to perform extraction of a speaker identity, and obtain first embedding representing a representation of the speaker identity;
input the first embedding to a speaker quantizer and obtain quantized second embedding;
input the text and the first embedding to a text prior encoder and obtain a first intermediate representation;
input the first intermediate representation and the first embedding to a prosody predictor, and add a prosodic hidden representation to the first intermediate representation, and obtain a second intermediate representation;
input the second intermediate representation and the first embedding to an intermediate decoder and obtain a final representation; and
convert the final representation to a waveform by using the decoder to generate speech.

18. The speech generation device of claim 17, wherein:
the program code is executed to further
input a linear spectrogram and the first embedding to a speech post encoder and obtain a third intermediate representation, and
align the third intermediate representation to the first intermediate representation.

19. The speech generation device of claim 18, wherein:
the program code is executed to further
implement zero-shot text-to-speech (TTS) based on the first embedding and the first intermediate representation, or implement zero-shot voice conversion (VC) based on the first embedding, the first intermediate representation, and the third intermediate representation.

20. The speech generation device of claim 18, wherein:
the program code is executed to further
implement random speaker text-to-speech (TTS) based on the second embedding and the first intermediate representation, or. implement random speaker voice conversion (VC) based on the second embedding, the first intermediate representation, and the third intermediate representation.
